(19) United States
(12) Patent Application Publication
(10) Pub. No.: US 2009/0006831 A1
(43) Pub. Date: Jan. 1, 2009

(54) METHODS AND APPARATUSES FOR CONFIGURING ADD-ON HARDWARE TO A COMPUTING PLATFORM

(76) Inventors: Wah Yiu Kwong, Beaverton, OR (US); Hong W. Wong, Portland, OR (US)

Correspondence Address: SCHUBERT, OSTERRIEDER & NICKELSON, PLLC;c/o Intellevate, LLC, P.O. BOX 52050, MINNEAPOLIS, MN, 55402, US

(21) Appl. No.: 11/772,152

(22) Filed: Jun. 30, 2007

(51) Int. Cl. G06F 15/177

(52) U.S. Cl. 713/1

(57) ABSTRACT

In one embodiment a method is disclosed for adding hardware device to a computing platform and configuring the newly installed hardware device. The method may include coupling hardware device to a computing platform, where the hardware device has memory and the computing platform has memory. The operating system of the computing platform may be detected by the hardware device and the platform may download and execute code stored by the hardware device to and in response to the executed code the computing platform may locate a source for a download of driver information for the added hardware. Other embodiments are also described.

### FIELD OF INVENTION

Some embodiments disclosed herein relate to the field of computers and more particularly, to methods and apparatuses for adding hardware to a computing platform and to configuring the computing platform.

### BACKGROUND

Personal computers can be purchased with a variety of options. Generally, the options that a computer user purchases will depend on what kind of tasks the user will be performing. Some options or features that a user may desire for their computer may not be available from the factory. Thus, users often purchase non original equipment, “add-ons,” peripheral hardware modules or removable hardware for their computer. Adding such hardware generally requires a user to conduct a set up process that modifies the operation of the computer. Such a modification process to computer operation may require simple tools but more importantly, adding such peripherals typically requires the user to load software such that the processor can communicate with, transact with or operate the added hardware.

When a peripheral device or add on device is purchased, the manufacturer of this add on hardware typically provides software (a driver for the peripheral hardware) that can be loaded onto the computer or computing platform. Among other things, this software can be transferred from portable media such as a compact disk (CD) to solid state memory on the computing platform. When the driver is stored on the computing platform, it allows the processor to load the software when the platform boots and then the processor can interact with the newly installed peripheral hardware. Thus, peripheral software is often packaged with the hardware device on a CD and the user must insert the CD into a CD drive and request that the computer system load the software into non-volatile memory or system memory before the processor can interact with the newly installed hardware. If a computer has a failure, and software must be reloaded, the owner is required to relocate the software in order to re-load it. Requiring a user to remember where the software has been stored can be an unpleasant time consuming experience. Also, the compact disk typically does not provide any visibility to the user for updating the software drivers. It can be appreciated that connecting devices and loading and reloading drives can be an onerous task and current methods of accomplishing such tasks are less than perfect.

### BRIEF DESCRIPTION OF THE DRAWINGS

FIG. 1 depicts an embodiment of a processing system with a removable hardware device;

FIG. 2 depicts a block diagram of another processing system; and

FIG. 3 depicts a flow diagram of an operation for attaching hardware to a processing system.

### DETAILED DESCRIPTION OF EMBODIMENTS

The following is a detailed description of some of the embodiments of the invention depicted in the accompanying drawings. The embodiments are in such detail as to clearly communicate an invention. However, the amount of detail offered is not intended to limit the anticipated variations of embodiments; but on the contrary, the intention is to cover all modifications, equivalents, and alternatives falling within the spirit and scope of the some embodiments of the invention as defined by the appended claims. While specific embodiments will be described below with reference to particular circuit or logic configurations, those of skill in the art will realize that some embodiments of the invention may advantageously be implemented with other similar configurations.

Hardware that may be added to a computer can be referred to as “add-on” hardware. Add-on hardware typically requires software and this software is commonly referred to as a driver that can “drive the hardware. A driver can be thought of as a miniature program or set of instructions that act like a translator, converting the output from one device into data that another device can understand. For example, a personal computer may require a device driver before it can process the signals from peripherals or add-on hardware such as a network, a mouse, a scanner, a hard drive, a fax-modem, CD-ROM drives, printers, and other peripherals. As stated above, device drivers may be transferred to a hard disk of the computing platform and the instructions may be loaded into local memory of the system when a system boot up occurs at power up. A driver may control the exchange of information between an application or operating system being executed by a processor and the added hardware device.

Driver type instructions may also facilitate access to communication ports or expansion slots either directly or via the operating system or basic input/output system (BIOS) of the computer. It can be appreciated that there may be a vast number of different peripheral devices and an off the shelf computing platform can't be expected to store instruction on how to interact with all of these available/add-on devices. In addition the driver may act as an intermediary between a processing unit and a peripheral device. The processing unit may send a command to the device driver, which translates that command into a one meaningful to the peripheral device. A device driver may contain device-specific code that may be utilized to control and communicate with hardware.

The driver may translate operating system based requests (such as input/output requests) into a format that may be recognizable by specific hardware, such as adapters. Driver software may handle interrupts and control a computer hardware component or peripheral and translate a user's logical device commands to physical commands. A device driver may enable another program, typically, an operating system (e.g., Windows, Linux,) to interact with a hardware device. A driver may be essentially an instruction manual that provides the operating system with the information on how to control and communicate with a particular piece of hardware.

For a number of reasons, the loading of peripheral software and the start up of the peripheral can be a significant task and a significant hassle for the user/owner of the computer. During the physical connection and software loading process many things can go wrong. Often the operating system of the computer will ask questions of the installer during the installation and if a wrong answer is provided by the user, the loading process may fail and the add on devices may not become operable. It can be appreciated that the start-up/connection process may fail in many other ways. For example, there may be a start-up sequence that needs to be followed and performing operations out of sequence may also lead to an inoperable peripheral. Further, a computer owner may not have a CD reader or may be installing CD reader, and thus, the user may not be able to load the software in the form provided.

Accordingly, in some embodiments a method is disclosed for adding hardware to a computing platform and configuring the newly installed hardware. The method may include coupling hardware to a computing platform, where the hardware has memory and the computing platform has memory. The operating system of the computing platform may be detected by the hardware and the platform may execute code stored by the hardware to locate a source for a download of driver information for the added hardware.

In one embodiment, the source may be the memory of the hardware module and in another embodiment the source may be a website that has an Internet address where the Internet address may be stored in the memory of the hardware module. The computing platform may check the website to see if the hardware module memory has the current version of the driver and determine what source should be utilized for the download. Once the current driver is located and downloaded the computing platform may execute the driver instructions and the platform may transact with the added hardware.

After the driver is downloaded and stored in solid state memory of the computing platform a configuration setting of the computing platform may be changed and the system may be automatically rebooted such that the hardware device is ready for operation. In one embodiment, the hardware module memory may be utilized by other applications as supplemental memory when memory is available on the hardware module memory.

In another embodiment, an apparatus is disclosed that includes an interconnect structure having an input/output connection and a memory module coupled to the interconnect structure. The memory may store to store driver location instructions that when executed indicate where a driver may be located for the apparatus. A logic module may initiate a communication between a computing platform and the memory module via the input/output connection wherein the driver location instructions, when executed, allow the computing platform to locate and retrieve a driver for the apparatus. The apparatus may also include a memory module controller to control operations of the memory. The installation instructions may include instructions that when executed instruct the computing platform to interconnect with a network and download device driver instructions from the network.

In another embodiment, a method is disclosed for a computing platform to detect a hardware module that may be connected to the computing platform. The hardware module may have memory to store driver location instructions. The computing platform may also have memory to store the driver locator code and the driver when downloaded. The computing platform may receive driver location instructions from the hardware module memory based on an operating system of the computing platform and the computing platform may execute the driver code location instructions on the computing platform to determine a location to retrieve driver instructions. The computing platform may also determine an appropriate location to retrieve current instructions and then after retrieval the computing platform may execute the driver instructions.

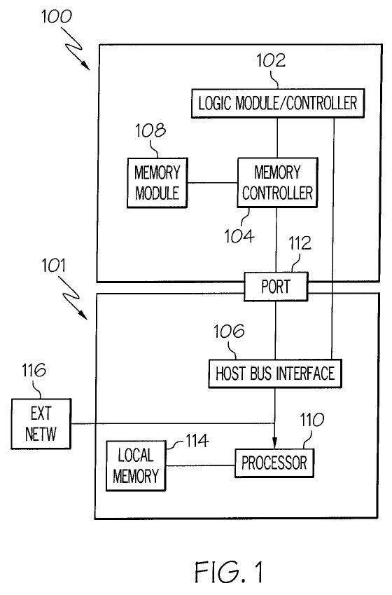

Referring to FIG. 1, a hardware device 100 such as a peripheral device is shown connected to a computing platform 101. The device 100 may include a controller such as a logic module 102, memory module 108, a memory controller 104 and an interconnect system that interconnects the above elements (102, 104, and 108) and interconnects the above elements 120, 104 and 108 to an external connection such as port 112. The computing platform 101 may include a host bus interface 106, a processor 110 system memory or local memory 114 and an external interconnect to interface the port 112. In one embodiment, the functions provided by the memory controller 104 may be integrated into the logic module/controller. There modules are shown separate for illustration purposes only.

The memory module 108 may be a non-volatile type memory that requires no quiescent power to store data or instructions or retain data. For example, the memory module 108 could be “flash” memory. In addition, the memory could be NAND or NOR type flash memory. In another embodiment memory module could be some form of an electronically erasable programmable memory (EEPROM) or a standard EPROM or some fusible link type memory.

Accordingly, the memory controller 104 could be a flash memory controller. In one embodiment, the logic module 102 memory module 108, memory controller 104 and interconnect may all be integrated on a printed circuit board where the printed circuit board may serve as an electrical and a mechanical interconnection between components 102, 104, 108 and 112. The port 112 could be a connector or a socket with contact and a wire pigtail. In addition, the port 112 could be a slot that accepts a card. For example, the port 112 could be a portion of an adapter card slot or a personal computer media card interface (PCMCIA) adapter type receptacle.

The memory module 108 may store instructions and data that may be automatically retrieved by, and utilized by the processor 1 10 to interact with the device 100 when the hardware 100 is connected to the computing platform 101. The basic operation of this feature may have similarities to what may be referred to as “plug and play” where a processor executing an operating system may detect the connection of the hardware and perform an action. The instructions and data stored by memory module 108 may be referred to as a device driver where a driver may include instructions, applications or utilities that may be utilized by the processor 110 to operate, communicate with, or interact with the hardware device 100.

During an installation procedure for a piece of add on hardware such as device 100, the device 100 could be connected to the computing platform 101 via port 112. The operating system instructions executed by the processor 110 may periodically sample the port 112 to see if a device 100 may be connected to the port 112. When the processor 110 determines that a device, such as device 100, has been connected to the port 112, the processor 110 may query the device 100 and access memory module 108 via the host bus interface 106, the port 112 and the memory controller 104.

The processor 110 may accesses at least a portion of the contents of memory module 108 and the processor may retrieve download instructions including a source for the download based on the operating system of the computing platform 101. The contents of memory module 108 may also include instructions that may be executed by the processor 110 and when such instructions are executed the processor 110 may auto-load the drivers to local memory 114. A driver or driver instruction or software when executed may take hardware (e.g. 100) in and out of service, set hardware parameters, facilitate transmitting data between memory 114 and the device 100, schedule multiple uses of the device 100 on behalf of multiple processes, and handle I/O errors to name a few operations.

This auto-load may be accomplished in many ways. In one embodiment, the driver instructions may be located in memory module 108 and may be downloaded into local memory 114 utilizing download instructions stored in memory module 108 as the instructions are executed by processor 110. In another embodiment, the auto-load may occur when the processor 110 accesses driver loading instructions stored in memory module 108 and the instruction executed by processor 110 may control the processor to access an external network 116 to download the instructions. The external network 116 could be a wide area network such as the Internet and the contents in memory 108 could include a World Wide Web or Internet address as the source for such a driver. In addition the memory module 108 could include a version or identifier of the stored code and the processor 110 may determine or select a “most current” version of the code such that a latest version of the code or an appropriate version of the code gets loaded into memory 114.

Thus, in one embodiment peripherals, adapters or embedded modules may have built in non-volatile read only memory 108 such as NAND type random access memory and the processor 110 may automatically execute such code. Accordingly, when the device 100 is connected to a computing platform 101 the processor 110 may locate, and then download the driver software needed to run the peripheral (i.e. 100) from the non-volatile peripheral memory 108. Such a configuration may improve the ease of set up on a computer 101 and provide addition plug and play features for add on hardware and computing platforms. Such a configuration may be considered as a “plug and play” configuration with significant improvements over existing plug and play systems because the download process may occur without user intervention. In addition, storing peripheral software or device driver software for the processor 110 on the device 100 or peripheral hardware may provide quicker installation times when compared to traditional set ups.

As utilized herein, hardware or device 100 may be understood to be any item of hardware that may somehow be coupled or connected to the computer's processor. For example a wireless router may be coupled to the processor 110. Accordingly, hardware device 100 or peripheral may be controlled by the processing unit 110. In addition, hardware device 100 may be added to an existing system and removed from a system and may be considered as removable hardware. Hardware device 1000 may perform as an adapter and such hardware may include a personal computer card, a peripheral component interconnect (PCI) type device or an express card, a display, a printer, a mouse, a communications adapter or a software module that manages access to any hardware device to name a few.

An express card may be understood as third generation personal computer technology that may be similar to a generated by the personal computer memory card international association (PCMCIA). Express cards may use a uniform serial bus version 2.0 type interface or a single lane personal computer interface (PCI) express channel. Other peripheral devices may include embedded modules such as a “mini card.” A PCI compliant device may provide a high-speed connection for small computer system interface (SCSI) cards, video cards, sound cards, modems, video capture cards, etc. Thus, these devices allow a way to add features to a computer and such a methodology may be the most popular way to add devices to a computer.

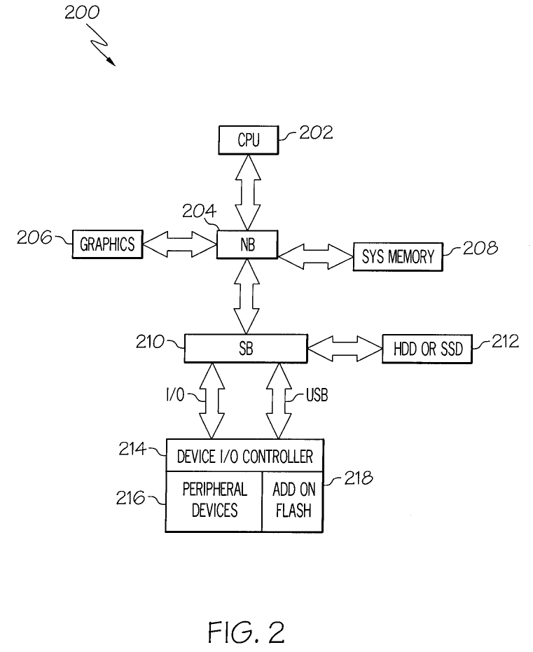

Referring to FIG. 2 another computing platform 200 is disclosed. The computing platform 200 may include a central processing unit (CPU) 202, a north bridge 204, a south bridge 210, a graphics card 206, local system memory 208, a solid state drive or hard drive 212. The south bridge 20 may interconnect with a device controller 214 via an input output (I/O) bus or a uniform serial bus (USB). The device input/output (I/O) controller 214 may connect the south bridge 210 to devices 216 and flash memory 218.

During operation, an operating system may be stored in memory 208 and the CPU 202 may access memory 208 and may execute instructions to control or interact with devices 216. In accordance with one embodiment of the disclosure, an operating system level plug and play implementation may facilitate an auto-down-load of peripheral software from local flash 218 to memory 208. Accordingly, the peripheral software may be downloaded from non-volatile memory or local flash memory 218 on the peripheral device 216 into main system memory 208 on the computing platform.

Accordingly, the software drivers for this enhance plug and play may be provided as part of a hardware design where non-volatile dedicated memory 218 on the hardware/peripheral device may be incorporated as part of the device. The dedicated memory 218 may be utilized for storing the driver for “itself” (a device may store its drivers on-board). The instructions stored in local flash 218 may also make periodic requests for updates driver over a network such as the Internet on a periodic basis.

As stated above, novice computer users and skilled computer users alike often have a very hard time installing new features onto their computers. It can be appreciated that considerable time and energy has been invested by add on device manufacturers to make adding hardware products to a computing platform more user friendly. Providing add on hardware with on board memory 218 that may control the set up of the added hardware via a CPU 202 may simplify the set up process and may resolve many problems with set up, thereby enhancing a users experience with a computer or computing platform.

Generally, installation of a plug-n-play device requires the computing platform 200 to locate and load software or a device driver. Typically, during an install the user must instruct the computer to search for a particular piece of software. In accordance with the disclosure, the process of adding a driver for add on hardware may be streamlined by avoiding the requirement that the user search for, and locate a device driver because the device driver may be stored in local flash 218. Flash 218 may contain instructions that provide a source for the CPU 202 to access and retrieve or download the driver. The source may be local flash 218 or a network address.

It can be appreciated that if a computer locks up and code such as driver code may be corrupted (this phenomenon is commonly referred to as “a computer crash”) access to uncorrupted data within the computing platform may be impossible. In accordance with some embodiments of the disclosure, the owner will not have to find drivers for re-installation of software as the non-volatile memory (flash memory 218) in the hardware or peripheral device may be utilized to reload an uncorrupted copy of the driver.

Accordingly, the computing platform may be able to reboot because the software required to operate the peripheral driver 216 may be reloaded when it may be determined that the driver may be inoperable. Thus an auto-load and a reboot may occur after a crash without user intervention. Further, after a crash or at scheduled time intervals the hardware device 216 may automatically activate a download to update its driver. In yet another embodiment the device could store code for other applications such as operating system code, firmware code, basic input output system code embedded controller code and the like. The device could also request updates for this other software.

In one embodiment, local flash 218 may be utilized to storage data or instructions for other applications that may be unrelated to the operations done by the hardware devices 216. Such a surrogate memory usage may occur when the devices 216 may be in a system sleep state/mode. Thus, flash memory 218 may be utilized as a deep data buffer while the device 216 may be placed into periodic sleep state for power savings and the device driver code may be securely stored in memory 208.

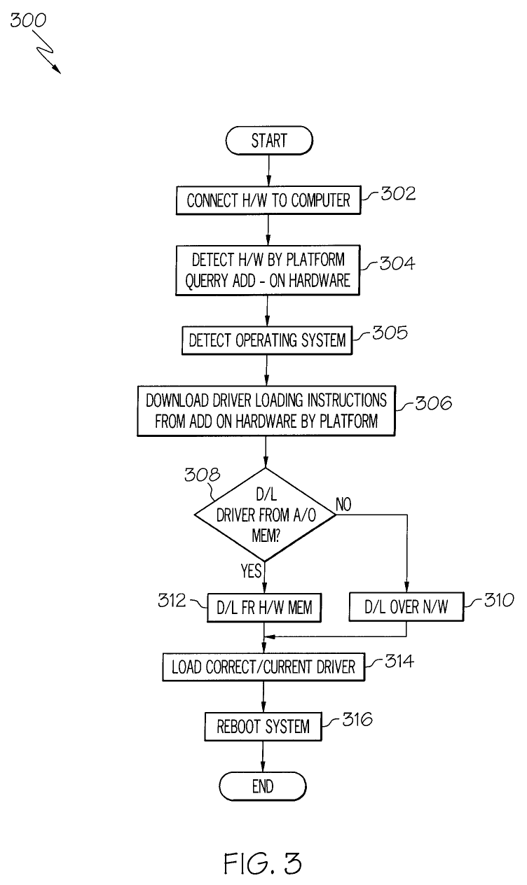

Referring to FIG. 3, a flow diagram for a method to connect a piece of hardware such as a peripheral device or a removable piece of hardware to a computing platform is disclosed. A user may install the hardware to a computer or a computing platform as illustrated by block 302. The computing platform may be running and executing operating system code and the operating system code may periodically check ports or connection locations for added hardware as illustrated by block 304. When the hardware may be detected the processor executing operating system code may query the hardware. The hardware may detect what operating system may be being run by the processor as illustrated by block 305.

As illustrated by block 306, the processor may load and execute instructions regarding a procedure for loading a driver for the detected hardware. In other embodiments the device may be a memory device that stores operating system software, firmware etc such that the system could boot off of the device and get downloads based on the instructions retrieved from the device. The instructions may be stored within memory onboard the hardware device and the hardware may help to facilitate the loading of such instructions. The instructions may also provide decisions that allow the processor to an appropriate driver possibly a most current version of the driver or just a driver that will provide adequate operation.

As illustrated by decision block 308 the processor executing the code retrieved from the hardware memory may decide if it should download the driver from the add on hardware memory and the driver may then be downloaded from add on hardware memory as illustrated by block 312. Downloading code or a file over a network such as the Internet can be achieved in many different ways. For example downloading can be achieved using a file transport protocol (FTP) or a point to point (PTP) or peer to peer (PTP) system. FTP is a computer language used for file transfer from computer to computer across networks such as the World Wide Web.

If the processor determines that a website may be a better source for the driver then as illustrated by block 310 the driver may be downloaded over a network. As illustrated by block 314 an appropriate driver may be loaded and stored in solid state memory of the computing platform. In one embodiment, after the driver may be loaded the computing platform may be rebooted such that the boot configuration may be altered. In other embodiments a reboot may not be necessary.

In accordance with some embodiments of the disclosure, an operating system may be created that automatically executes driver locater code and then uses the driver locater code to download a device driver and install it in memory that may be local to the processor. Then the code from the installed hardware may also request that the processor automatically reboot the system such that the auto-configuration and loading of the drivers from local memory may be tested and the installed driver may be run.

As stated above, in addition, after the memory provided by the removable hardware provides such an auto configure the memory of the hardware may be utilized as cache for certain operations. For example flash memory in a WiMax adapter may be utilized to buffer streaming video feeding to the system so that the system. This may be advantageous when the processor periodically puts the adapter into sleep state to conserve power.

Other features that may be stored in the hardware memory include device driver update scheduling or a watchdog program. The operating system may have a routine to support such feature and the driver update schedule may turn this feature on or off. In addition the automatic update process may provide for the updated driver instructions to be stored into the memory of the added hardware device.

Another embodiment of the invention may be implemented as a program product for implementing the arrangements described above. The program(s) of the program product defines functions of the embodiments (including the methods described herein) and may be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks.

In general, the routines executed to implement the embodiments of the invention, may be part of an operating system or a specific application, component, program, module, object, or sequence of instructions. The computer program of some embodiments of the invention typically is comprised of a multitude of instructions that will be translated by a computer into a machine-readable format and hence executable instructions.

Also, programs may be comprised of variables and data structures that either reside locally to the program or may be found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. It is understood that the form of the embodiments shown and described in the detailed description and the drawings are to be taken merely as examples. It is intended that the following claims be interpreted broadly to embrace all the variations of the example embodiments disclosed.

Although the invention and some of its advantages have been described in detail for some embodiments, it should be understood that various changes, substitutions and alterations may be made herein without departing from the spirit and scope of the invention as defined by the appended claims. Although an embodiment of the invention may achieve multiple objectives, not every embodiment falling within the scope of the attached claims will achieve every objective. Moreover, the scope of this document is not intended to be limited to the particular embodiments of the process, machine, manufacture, composition of matter, means, methods and steps described in the specification.

As one of ordinary skill in the art will readily appreciate from the teachings herein processes, machines, manufacture, compositions of matter, means, methods, or steps, presently existing or later to be developed that perform substantially the same function or achieve substantially the same result as the corresponding embodiments described herein may be utilized according to some embodiments of the invention. Accordingly, the appended claims are intended to include within their scope such processes, machines, manufacture, compositions of matter, means, methods, or steps.

What is claimed is:

1. A method comprising:
coupling a hardware module to a computing platform, the hardware module having memory to store driver location instructions of the hardware module, the computing platform having an operating system and memory;
detecting the coupled hardware by computing platform executing the operating system;
downloading the driver code location instructions from the hardware module memory based on the operating system executing the driver location instructions; and
determining a location to retrieve driver instructions.

2. The method of claim 1, further comprising retrieving the driver instructions from one of a network or the hardware module memory and storing the driver instructions in the memory of the computing platform.

3. The method of claim 1, further comprising modifying a boot process of the computing platform based on the loaded driver instructions.

4. The method of claim 1, wherein the driver instructions are one of a device driver, a utility and an application.

5. The method of claim 1 further comprising controlling the hardware module using the device driver.

6. The method of claim 1, further comprising utilizing the hardware module memory to store one of data or instructions from an application that is unrelated to operation of the hardware module.

7. The method of claim 1, further comprising determining if the instructions are current instruction and requesting another set of instructions based on the determination.

8. The method of claim 1, further comprising deleting the driver instructions from the hardware module memory and reloading driver instructions in the hardware module memory.

9. The method of claim 1, further comprising updating the device driver software utilizing instructions stored by the removable hardware memory where the update comes from one of the hardware module memory or over a network.

10. An apparatus comprising:
an interconnect structure having an input/output connection that is pluggable into a computing platform;
a non-volatile memory module coupled to the interconnect structure to store driver location instructions of the apparatus;
a logic module to initiate a communication between a computing platform and the non-volatile memory module via the input/output connection wherein the driver location instructions, when executed, instruct the computing platform to locate and retrieve a driver.

11. The apparatus of claim 10, further comprising a memory module controller to control operations of the non-volatile memory.

12. The apparatus of claim 10, wherein the installation instructions comprise instructions to instruct the computing platform to interconnect with a network and download device driver instructions from the network.

13. A method comprising:
detecting a removable hardware module connected to a computing platform, the removable hardware module having memory to store driver location instructions of the removable hardware module, the computing platform having memory;
receiving driver location instructions from the removable hardware module memory based on the detection of the removable hardware driver location instructions; and,
executing the driver code location instructions by the computing platform wherein the driver location instructions when executed provide a location to retrieve driver instructions.

14. The method of claim 13, further comprising executing the driver instructions.

15. The apparatus of claim 13, further comprising determining an appropriate location to retrieve the instructions.
